(19) United States
(12) Patent Application Publication
(10) Pub. No.: US 2005/0115955 A1
(43) Pub. Date: Jun. 2, 2005

(54) Micro-heating apparatus for locally controlling the temperature in a mold

(76) Inventor: Jung-Tang Huang, Tao-Yuan Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/707,240

(22) Filed: Nov. 30, 2003

(51) Int. Cl. H05B 1/02

(52) U.S. Cl. 219/548

(57) ABSTRACT

A micro-heating apparatus for locally controlling a temperature in a mold includes substrate, at least a micro-heating module installed on the substrate, and at least a temperature detector installed on the substrate near the micro-heater for measuring the local temperature. The micro-heating module includes a micro-heater, an external power circuit, and a connection electrode for connecting the external power circuit and a programmable external power device. The substrate with the micro-heating module and the temperature detector thereon is capable of combining with the mold so that the micro-heater contacts a plastic material in the mold. The programmable external power device is used for connecting to the external power circuit to control the micro-heater to heat the plastic material so as to control the temperature when the temperature around an interface of the plastic material and the micro-heater is measured.

### BACKGROUND OF INVENTION

1. Field of the Invention

The invention relates to a micro-heating apparatus, and more particularly, to a micro-heating apparatus for locally controlling a temperature in a mold.

2. Description of the Prior Art

According to the development of the IC fabrication in recent years, semiconductor technology has come to maturity. Therefore semiconductor products have been pushed for size reductions to match the trend of market requirements. The micro-electro-mechanical system (MEMS) technology based on the semiconductor process also has a huge amount of applications. For example, the elements with microstructures, such as the micro-sensor, micro-actuator, and micro-switch, and the systems on a chip (SOC) or the lab on a chip (LOC) are common applications of MEMS. Micro-heaters fabricated by MEMS are widely applied in many documents. The micro-heaters are commonly used in air detectors, chemical detectors, and polymerase chain reaction (PCR) biological chips to provide a local heating function so that to supply a local micro-heat supply in a micro-system chip. In a plastic injection-molding fabrication, the cooling process occupies approximately 70% of the cycle time. Therefore the temperature of the insert-mold in the mold plays an important role for the quality of the injection-molding fabrication. As a result, controlling the mold temperature is still a big issue in manufacturing.

In the prior art, hot oil pipes are employed to raise the mold temperature and serve as the heat source for controlling the temperature. However, the mass of the hot oil is larger, so that it takes several minutes to complete the heating process. Consequently, it will decrease profit and effect of the fabrication. On the other hand, an external power device is used to raise the mold temperature in the prior art. Referring to FIG. 1 and FIG. 2, the bar-type electric heaters 40 and the flat-type electric heaters 41 are examples of the prior-art external power device for heating the mold. Although the prior-art external power device can raise the mold temperature faster, the heat from the power device diffuses in all directions to the whole mold, and therefore the system will lose heat before the heat reaches the surface of the plastic material. Furthermore, since there is a certain heat transfer distance between the external power device and the surface of the plastic material, it is difficult to accurately control the temperature of the surface of the plastic material. As a result, the heating effect is not good enough when the prior-art external power device is employed.

Please refer to FIG. 3. FIG. 3 is a schematic diagram of a thin-film electric heater according to the prior art. According to U.S. Pat. No. 5,705,793A, a thin-film electric heater 42 is used for being a heat resource to raise the mold temperature. A metal thin film 42 is deposited on the surface of the insert-mold for serving as a resistance. Then, an external power device 25 is used to provide currents flowing through the thin-film resistance so as to heat the insert-mold. This design can improve the above-mentioned disadvantages and raise the heating effect. However, since the metal thin film 42 is deposited all over the mold, the temperature of the whole mold raises rapidly when the external power device 25 operates. Thus it still cannot match the requirement of locally heating the mold and controlling the temperature.

For the requirement of developing the micro-system chip, the micro-molding technology using high polymers as microstructures is developed. The insert-mold of the micro-molding technology, are formed by semiconductor processes, LIGA processes, or other processes similar to LIGA, replacing the traditional mechanical process. A stamper in an injection mold for producing a compact disk is one of the examples of masters. “Nanoreplication in polymers using hot embossing and injection molding” by H. Schift et al. points out that it will decrease the transfer ratio or cause the plastic material to incompletely fill the mold if the mold temperature is not high enough when the plastic material flows through the microstructures, with a high aspect ratio, of the stamper. In addition, “Hot embossing as a method for the fabrication of polymer high aspect ratio structures” by Holger Becker et al. mentions that the thermocycling at the insert-mold is an important factor for generating a better aspect ratio and filling performance of a hot embossing process. Recently, a lot of attention has been paid to the plastic wafer technology, as well as the silicon wafer technology, for developing a standard production process. For large-size and thick plastic wafers, H. Schift et al. tries to employ the hot embossing method to transfer the wafer level microstructure on plastic wafers. They heat the plastic to an appropriate temperature (usually more than the glass transition temperature), and supply compression to the mold to generate a fine microstructure or caves. When the method is applied to a thin plastic wafer with large area, the problems of having insufficient filling plastic material and the high-temperature requirement do not occur because the plastic material does not have to be melted. However, in contrast to the injection-molding method, the hot embossing method has the following disadvantages: (a) failing to completely transfer microstructures having a high aspect ratio; (b) failing to generate an uniform product; (c) having limitations to some geometric figures of microstructures; (d) easily occurrence of inner stress; (e) needing a vacuum system when requiring high quality.

### SUMMARY OF INVENTION

It is therefore a primary objective of the claimed invention to provide a micro-heating apparatus for locally controlling the mold temperature to solve the above-mentioned problems.

According to the claimed invention, the micro-heating apparatus comprises a substrate, at least a micro-heating module including a micro-heater installed on the substrate, and at least a temperature detector installed on the substrate near the micro-heater for measuring the local temperature. In addition to the micro-heater, the micro-heating module further comprises an external power circuit and a connection electrode for connecting the external power circuit and a programmable external power device. When the micro-heating module and the temperature detector are installed on the substrate, the substrate is capable of combining with the mold, so that the micro-heater can directly or indirectly contact the plastic material flow in the mold. The programmable external power device including a power supply and a temperature controller is used to connect to the external power circuit for controlling the micro-heater to heat the plastic material so as to control the temperature after the temperature around an interface of the plastic material and the micro-heater is measured.

It is an advantage of the claimed invention that the micro-heater and the temperature detector of the micro-heating apparatus fabricated by MEMS process are installed near the insert-mold so that the micro-heater can directly contact the plastic material. Therefore it is easy to get a high heating effect and the temperature of the plastic material can be directly controlled. Since the micro-heater can locally heat the plastic material and control the temperature, the plastic material can flow well on the insert-mold with microstructures during the filling and compressing process. Even when the microstructures have a high aspect ratio and a high flow length/sidewall thickness (L/T) ratio, the transfer ratio is still very high.

It is a second advantage of the claimed invention that the micro-heater is set near the insert-mold, so as to contact the plastic material directly. As a result, for some specific microstructures having high aspect ratios or high thickness variation of the geometric figure, the micro-heating apparatus can locally control the mold temperature to observe a better flow of the plastic material without raising the temperature of the whole mold.

It is a third advantage of the claimed invention that the micro-heater can heat the plastic material again and again so that it has a function of locally annealing the plastic material. In addition, the temperature detector can adjust the plastic material to an appropriate temperature. Accordingly, during the filling and compressing processes, the plastic material does not generate residual stress under pressure.

It is a fourth advantage of the claimed invention that a specific temperature gradient can be performed by using the micro-heater and the temperature detector during the cooling process. Therefore, the deformed situations of the plastic material caused by various temperature differences can be prevented.

It is a fifth advantage that the claimed invention fabricates the micro-heater and the temperature detector arranging in matrix by MEMS processes on the injection mold. Therefore the claimed invention can produce wafer-level plastic chips by an injection molding process, i.e. the plastic wafer technology. And the produced wafer-level plastic chips can be packaged together with a substrate having integration circuits and MEMS elements thereon so as to reduce the cost of production and raise the profit of mass production.

These and other objects of the present invention will be apparent to those of ordinary skill in the art after having read the following detailed description of the preferred embodiment that is illustrated in the various figures and drawings.

### BRIEF DESCRIPTION OF DRAWINGS

FIG. 1 is a schematic diagram of bar-type electric heaters according to the prior art.

FIG. 2 is a schematic diagram of flat-type electric heaters according to the prior art.

FIG. 3 is a schematic diagram of a thin-film electric heater according to the prior art.

FIG. 4 is a schematic diagram of a portion of an injection mold and the flow of the plastic material according to the present invention.

FIG. 5 is a schematic diagram of the plastic material flowing through a portion of the stamper during a hot embossing process according to the present invention.

FIGS. 6-8 are schematic diagrams of fabrication processes of the micro-heater according to the present invention.

FIG. 9 is a schematic diagram of the micro-heating module on chip according to the present invention.

FIG. 10 is a schematic diagram of the micro-heater having a function of indirectly heating the mold according to the present invention.

FIG. 11 is a schematic diagram of an optical fiber position carrier.

FIGS. 12 and 13 are schematic diagrams of the geometric pattern of the resistance micro-heater according to the present invention.

FIG. 14 is a portion of the injection mold according to the embodiment of the present invention.

FIG. 15 is a curve diagram of the injection and compressing processes vs. the operation of the micro-heater according to the present invention.

FIG. 16 is a schematic diagram of a plastic wafer of an optical fiber passive element according to the present invention.

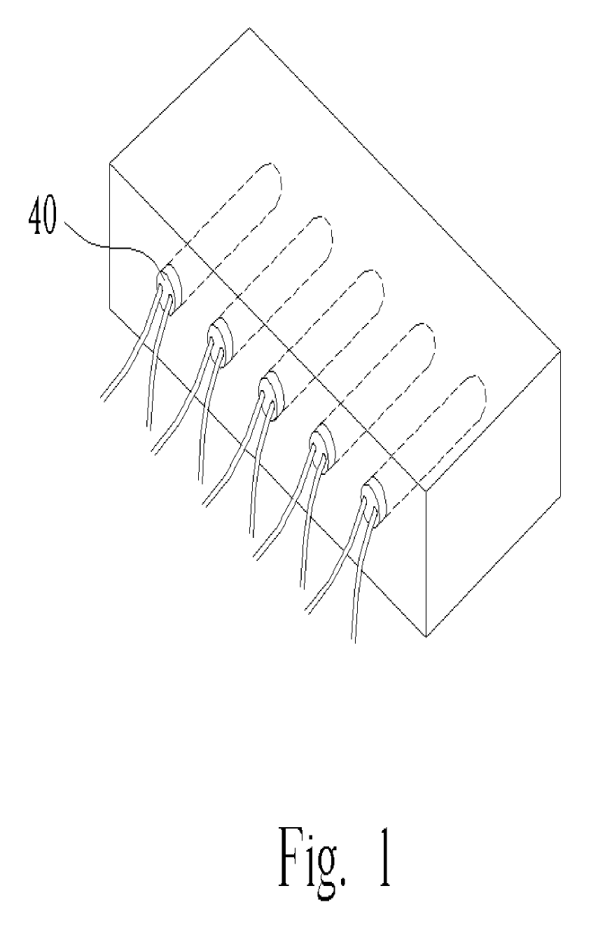

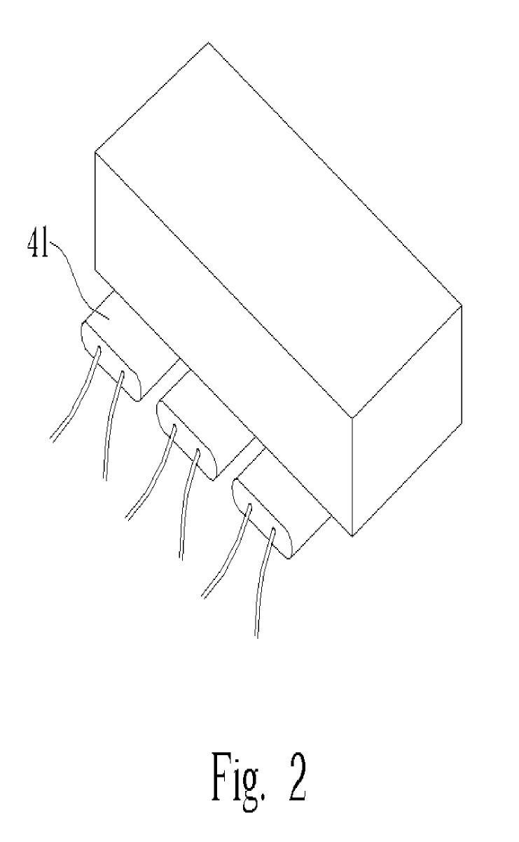

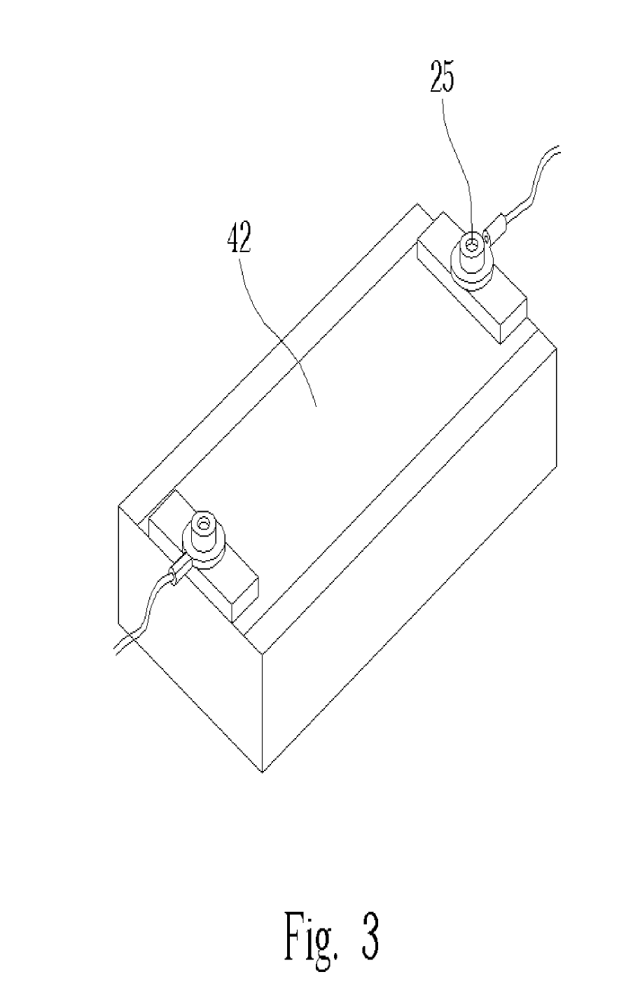

### DETAILED DESCRIPTION

The present invention comprises at least a micro-heater fabricated by MEMS set in an injection and hot embossing mold for supplying heat resource in a local portion of the mold when molding a product. The present invention further comprises at least a resistance temperature detector (R.T.D) near the micro-heater so that the micro-heater can locally control the mold temperature to an accuracy of ±5° C. Since the arrangement of the micro-heaters insures that the micro-heaters can locally heat the mold around the microstructures, the plastic material can flow in a better station in the mold having fine figures or high thickness variation during filling and compressing processes.

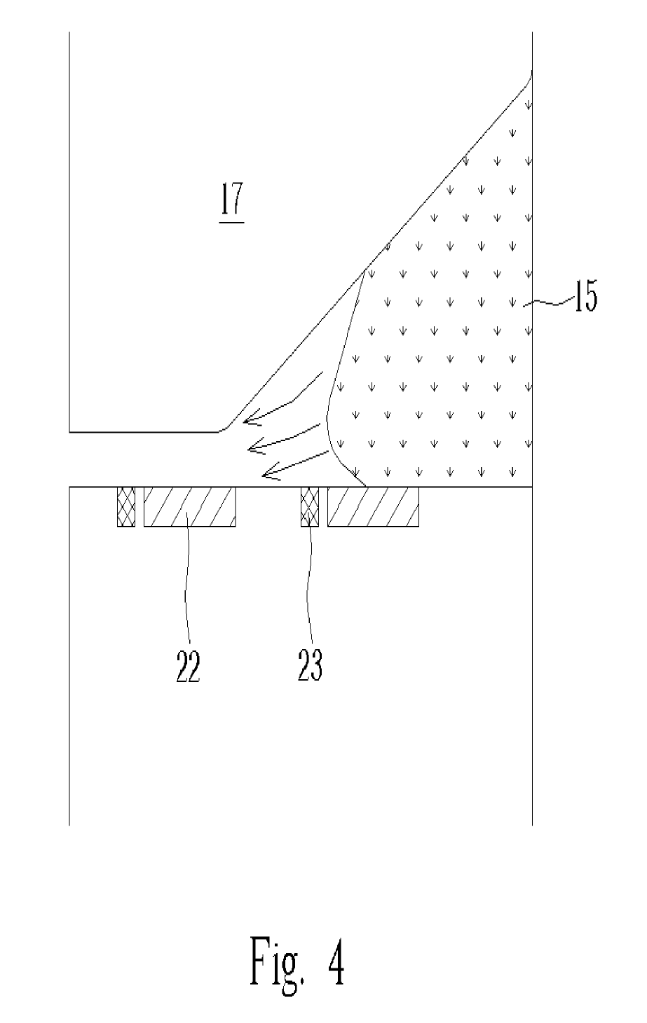

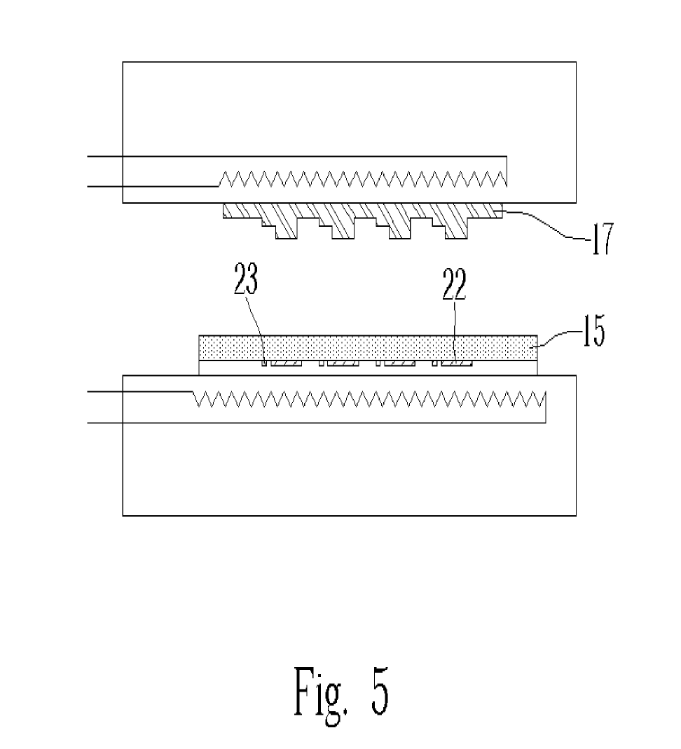

Please refer to FIG. 4. FIG. 4 is a schematic diagram of the plastic material 15 flowing through a portion of a stamper 17 according to the present invention. During the injection molding process, the plastic material 15 flows through the portion, with high thickness variation, of the stamper 17. In this situation, the plastic material 15 not completely filling the stamper or being heavily compressed, so as to generate great inner stresses, easily occurs. Therefore the micro-heater 22 and the temperature detector 23 for locally controlling the temperature can appropriately raise the mold temperature to reduce inner stresses and enable the plastic material to flow well. Please refer to FIG. 5. FIG. 5 is a schematic diagram of the plastic material 15 flowing through a portion of the stamper 17 during a hot embossing process according to the present invention. As shown in FIG. 5, when the stamper 17 compresses the pre-heated plastic material 15, the transfer ratio may be lower at the points of figures having high variation if the plastic material 15 cannot flow well. Furthermore, the plastic material 15 is compressed with high pressure, and therefore it will cause local inner stress after molding, resulting in the product shrinking during the cooling process. For preventing the product from deforming and affecting the size accuracy, the micro-heater 22 and the temperature detector 23 for locally control the mold temperature of the present invention can adjust the local temperature appropriately by a way of locally annealing the plastic material to remove the inner stress.

The operation of a thin-film resistance heater is to enable the current to flow through the resistance so as to generate heat. Therefore the micro-heater can be designed in various resistances and geometric figures according to the required heating temperature and range. The design theory is as the below formula:
R=ρ·L/A (1)
where:
R: resistance (O)
ρₛ: thin-film resistivity (Ω-μm)
L: length of the resistance (μm)
A: section area (μm²)

And an external power device can be utilized to control the power of the heater for raising the mold temperature to required temperature according to the formula:
P=V²/R (2)
where:
P: power (W)
V: voltage value (V)

On the other hand, the resistance value with a certain material of the R.T.D. changes according to temperature, for example, the resistance value of a metal resistance raises as the temperature becomes higher. When the heater produces heat, the resistance of the R.T.D. also changes because the R.T.D. is heated, so that the temperature can be conjectured by the change of the resistance. The design theory is based on the following formula:
R_{TS}═R₀×[1+α(TT₀)] (3)
where:
R_{TS}: resistance value at temperature T
R₀: resistance value at temperature T₀
α: temperature resistivity of the material
T: operation temperature of the heater
T₀: original temperature of the heater

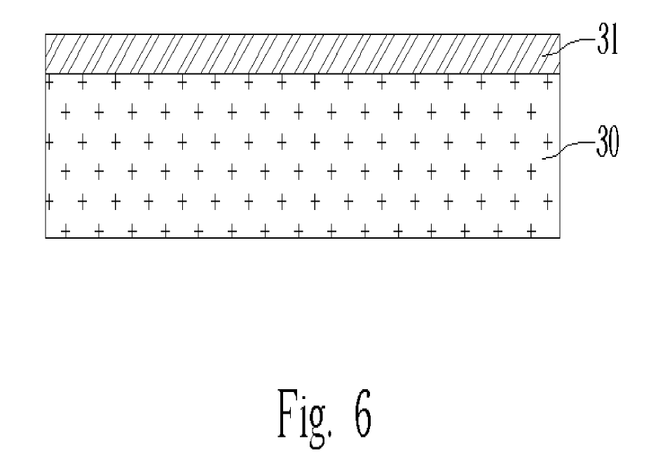

The detail fabrication process of the micro-heater and the temperature detector according to the present invention is described with reference to FIGS. 6-8, which are schematic diagrams of fabrication processes of the micro-heater according to the present invention.

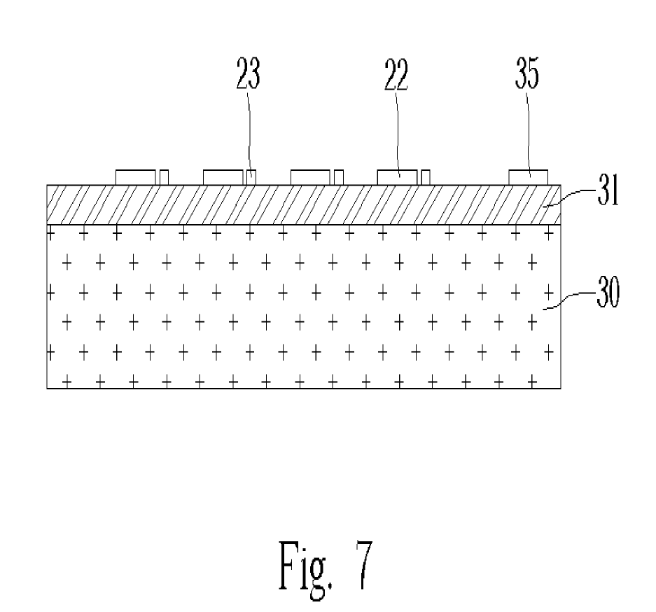

Please refer to FIG. 6. A first silicon oxide (SiO₂) layer 31 is deposited by an LPCVD process on a ceramic substrate 30 for serving as an insulation layer. The functionality of the first silicon oxide layer 31 is to insulate heat transfer between the elements and external environment to complete the effect of locally heating. As shown in FIG. 7, a lift-off process, one of the common MEMS system, is performed to form a patterned metal film. Wherein the lift-off process comprises coating a photoresist layer, performing an exposure-development process, depositing a metal film, and removing the photoresist layer. The pattern of the metal film includes micro-heaters 22, the temperature detectors 23, and the external power connection electrodes 35, and all of them are formed on a platinum layer to simplify the process. Furthermore, since the platinum material cannot stick well on the silicon oxide material, a titanium layer serving as a glue layer is deposited on the first silicon oxide layer 31 before depositing the platinum layer.

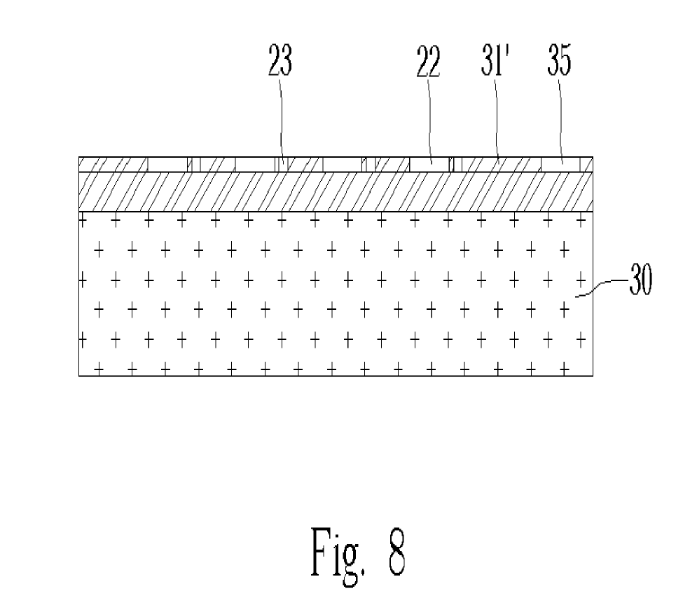

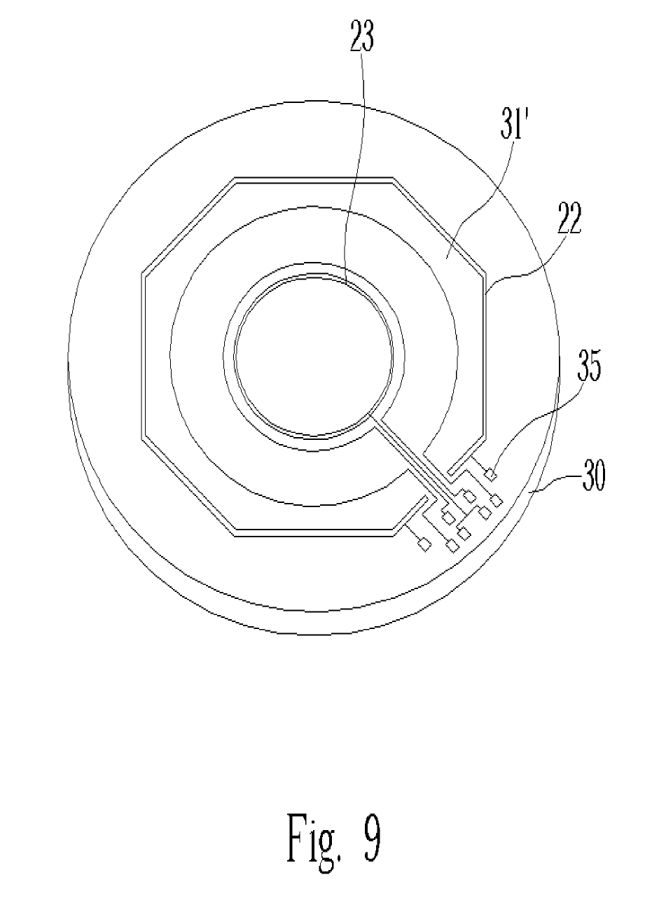

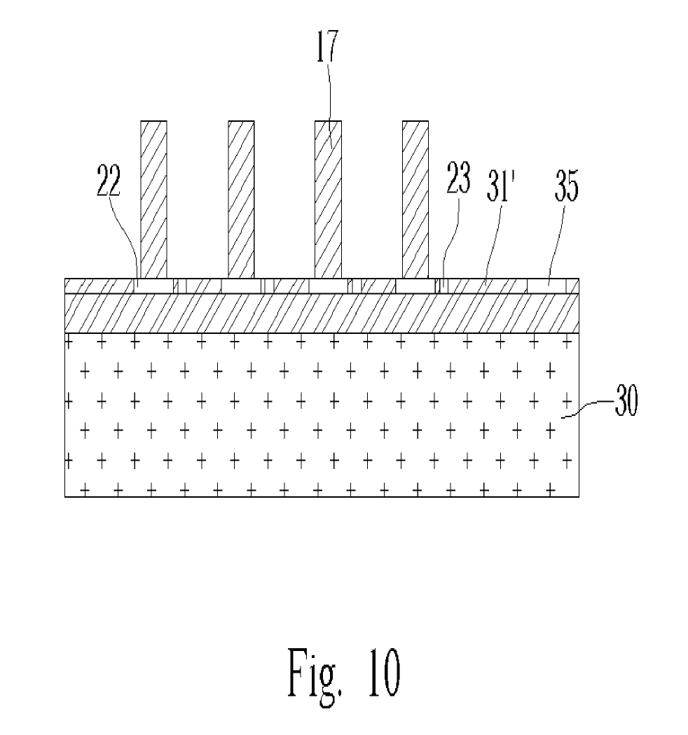

Referring to FIG. 8, a second silicon oxide layer is then deposited on the ceramic substrate 30. Then, a polishing process is performed to planarize the second oxide layer to expose metal film so that the metal film can directly contact the plastic material. And a silicon oxide layer 31′ comprising the first and the second silicon oxide layer is formed after the polishing process. Please refer to FIG. 9, the complete micro-heaters 22 and the temperature detectors 23 are shown in FIG. 9. On the other hand, the micro-heater 22 and the temperature detector 23 can be fabricated on the stamper 17, as shown in FIG. 10. Basically, the microstructures of the stamper 17 are fabricated directly on the substrate having the complete microheaters 22 and the temperature detectors 23 so that the microstructures can directly contact the micro-heaters 22. Therefore the micro-heaters 22 can heat the plastic material through the stamper 17.

It should be noticed that the micro-heater and the temperature detector of the present invention micro-heating apparatus may have a micro-single layer structure or a micro-multi layer structure with a plurality of serial or parallel geometry shapes. And those structures can be fabricated by a thin film process, a thick film process such as a screen printing process, or a low-temperature co-fired ceramics (LTCC) process.

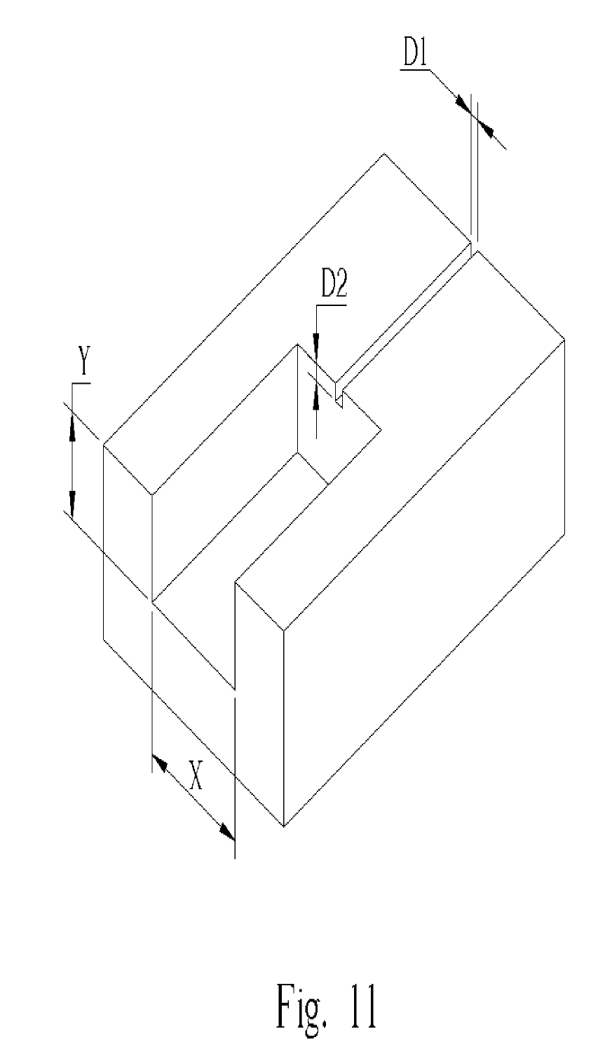

The present invention can be applied to the fabrication of optical fibers. Optical communication uses optical fibers as mediums to transfer optical signals. For reducing the loss of energy of signals, the optical fibers need to have a very high accuracy. Please refer to FIG. 11. FIG. 11 is a schematic diagram of an optical fiber position carrier, wherein the size of the symbols are X: 123 μm±1.00 μm; Y66 μm±1.00 μm; D₁: 8 μm±0.50 μm; and D₂: 8 μm±1.00 μm. The passive pigtail of optical fiber/waveguide shown in FIG. 11 is a very important position carrier, which has the error tolerance only about ±0.50 μm in position accuracy of the optical fiber core to the waveguide material. Since the size and accuracy are highly required, the mold temperature becomes even more important. As a result, the present invention micro-heating apparatus can be used to cooperate with the injection molding technology to locally heat the plastic material so that the plastic material can flow well and have uniform pressure during the compressing process. Thus a designed product without deformed shape can be produced after the cooling process.

For designing the position of the micro-heater and the temperature detector, a flow station analysis of injection molding process has to be performed to design the filling method, numbers, and positions. The flow station analysis comprises the flow of the melted plastic material and the arrangement of the temperature and pressure. In this embodiment, the connection point of the optical fiber and the waveguide has very fine size and high figure variation, so the present invention micro-heating apparatus should be set at the connection point to raise the transfer ratio of the injection molding process.

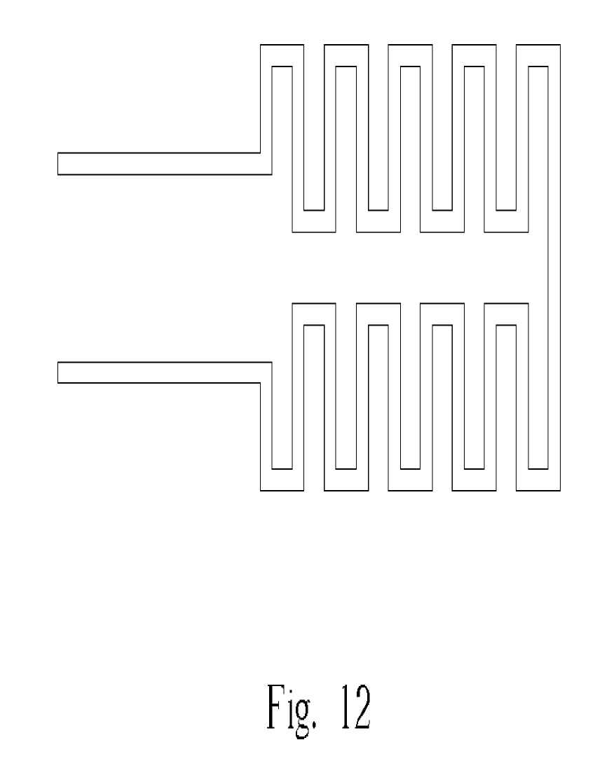

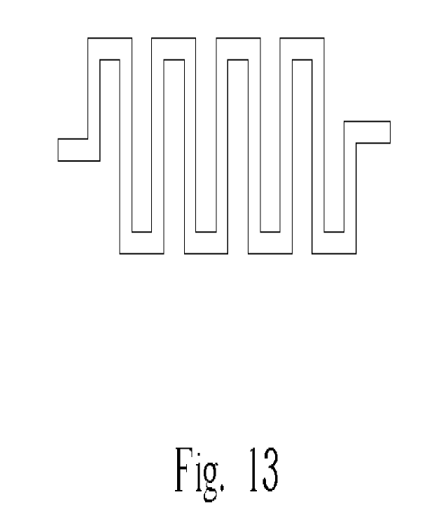

The micro-heating apparatus includes a micro-heating module and a temperature detector, wherein the micro-heating module comprises a micro-heater, an external power circuit, and a connection electrode for connecting the external power circuit and a programmable external power device, including a power supply and a temperature controller. The heating theory of the micro-heater is to use the external current or an external voltage to raise the temperature of the metal thin film. The material of platinum is a common material for heaters, which has a very sensitive resistance value to the temperature, thus platinum is also a common material for R.T.D. Accordingly, platinum is employed to fabricate both the micro-heater and the temperature detector so that only simple processes need to be used to fabricate the present invention micro-heating apparatus. In this embodiment, the MEMS process is used to fabricate the platinum thin-film micro-heating module. During the fabricating process, the resistance of the metal thin film is measured as 1.74 μm-ohm by a 4-point probe detector. Therefore, a micro-heater with a resistance of 100 ohm is designed, which has a multiform pattern as shown in FIG. 12 or FIG. 13.

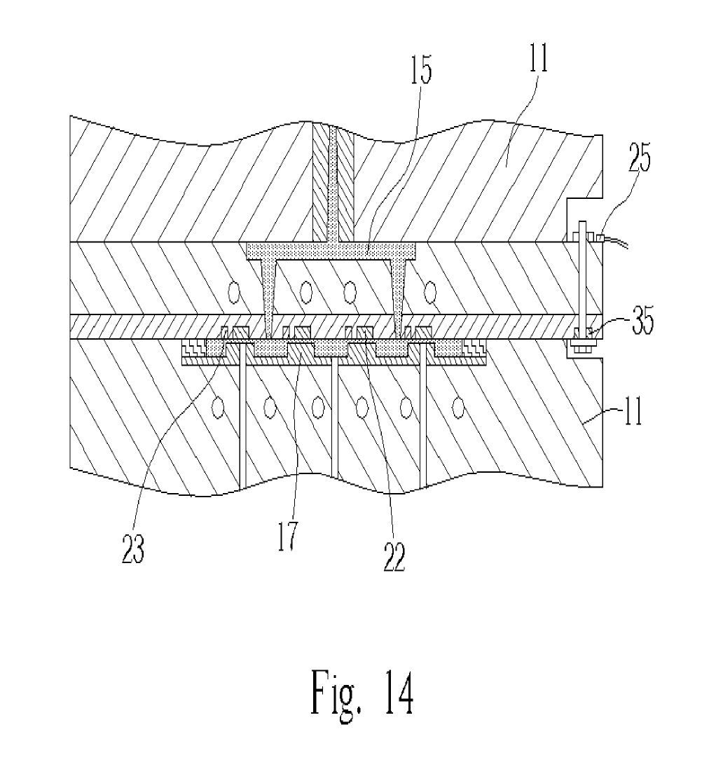

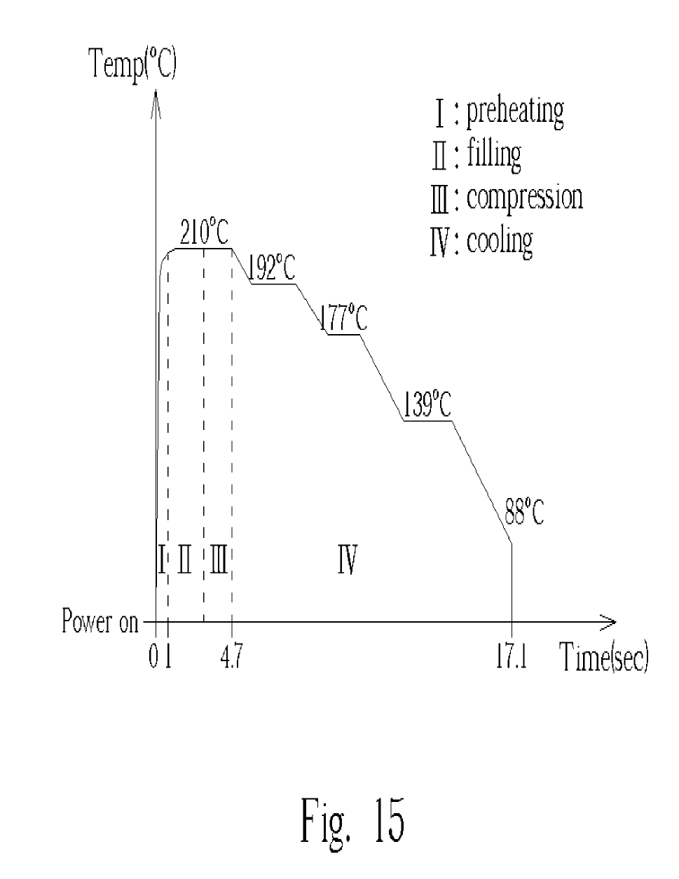

Please refer to FIG. 14. FIG. 14 is a portion of the injection mold 11 according to the embodiment of the present invention. The micro-heating apparatus is installed on an injection compression mold. Before filling the plastic material, the temperature around the interface of the plastic material flowing through and the micro-heater is measured, in which the plastic material may easily solidify. During the injection process, the programmable external power device is used to raise the mold temperature to a required temperature of 210° C. before closing the mold 11. Then, a space of 0.3 mm should be left when closing the mold 11. The melted plastic material 15 is filled and injected into the cavity. Since the micro-heaters 22 are already installed and provide required temperature at the point the plastic material 15 may block or fill incompletely, the plastic material 15 can be heated again to have a better flow station when it flow through the mold 11. After a few seconds of completely filling the plastic material 15, a compression process is performed while the mold 11 is closed completely so that the microstructures can be transferred on the product in good condition. At this time, the micro-heaters 22 are used to locally anneal the plastic material 15 at the point with microstructures and high aspect ratio to reduce residue stresses. Adjusting a power of the micro-heaters 22 and controlling a feedback of the temperature detectors 23 can generate a required specific temperature gradient to control the temperature of the whole entirety of the plastic material 15 until the cooling process is done. Please refer to FIG. 15, which is a curve diagram of the injection and compression process vs. the operation of the micro-heaters 22.

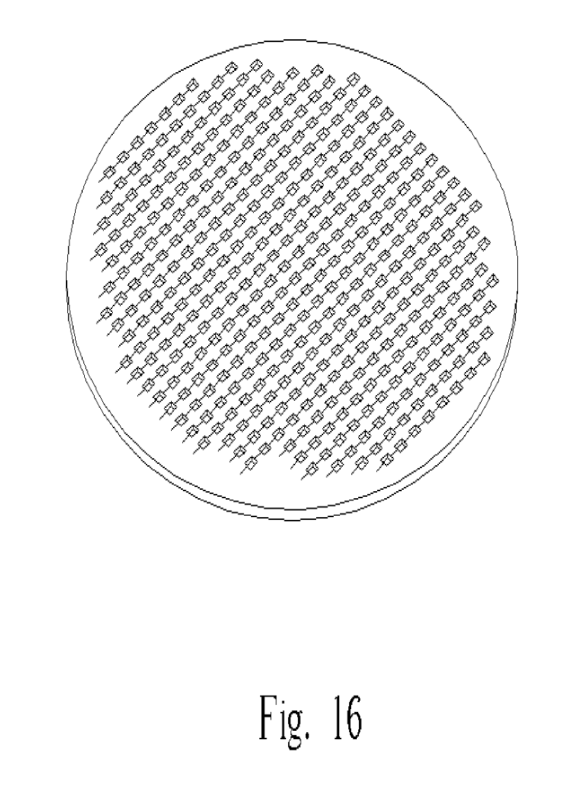

The present invention micro-heating apparatus can apply to a direct pressure injection compression machine. For example, the micro-heating apparatus fabricated by MEMS process is installed on the machine for locally controlling the mold temperature. And the injection process is performed by the machine with cooperation by the micro-heating apparatus to produce a plastic wafer with a diameter of 14 inches, as shown in FIG. 16.

In contrast to the prior art, the present invention micro-heating apparatus can locally heat the injection mold and control the mold temperature. By cooperating with the injection compression technology, the flow ability, transfer ratio of microstructures, and mold temperature control of the plastic wafer technology can have a better performance by using the present invention micro-heating apparatus. Furthermore, in addition to injection molding technology and injection compression mold, the present invention also can be utilized on hot embossing technology or other technologies in need of locally controlling the temperature to reduce the inner stress and gain high aspect ratio.

Those skilled in the art will readily observe that numerous modifications and alterations of the device may be made while retaining the teachings of the invention. Accordingly, the above disclosure should be construed as limited only by the metes and bounds of the appended claims.

1. A micro-heating apparatus for locally controlling a temperature in a mold, the micro-heating apparatus comprising:
a substrate;
at least a micro-heating module installed on the substrate, the micro-heating module comprising:
a micro-heater;
an external power circuit; and
a connection electrode for connecting the external power circuit and a programmable external power device; and
at least a temperature detector installed on the substrate near the micro-heater for measuring the local temperature;
wherein the substrate with the micro-heating module and the temperature detector is capable of combining with the mold so that the micro-heater directly or indirectly contacts a plastic material in the mold, and the programmable external power device including a power supply and a temperature controller is used for connecting to the external power circuit to control the micro-heater to heat the plastic material so as to control the temperature when the temperature around an interface of the plastic material and the micro-heater is measured.

2. The micro-heating apparatus of claim 1, wherein the micro-heater and the temperature detector have a micro-single layer structure or a micro-multi layer structure with a plurality of serial or parallel geometry shapes fabricated by a thin film process such as a micro-electromechanical system process, a thick film process such as a screen printing process, or a low-temperature co-fired ceramics (LTCC) process.

3. The micro-heating apparatus of claim 1, wherein the micro-heating apparatus is set in an injection mold, an injection compression mold, a hot embossing mold, or other devices in need of controlling a local temperature.

4. The micro-heating apparatus of claim 1, wherein the micro-heater indirectly contacts the plastic material in the mold means that the mold further comprises a stamper with a plurality of microstructures set on the substrate, so that the micro-heater is capable of heating the plastic material through the stamper.

5. A method of fabricating a plastic chip having a plurality of microstructures with a fine size and a high aspect ratio, the method comprising:
installing the micro-heating apparatus of claim 1 in the mold;
performing an injection compression process for gaining a better transfer ratio during the compressing process; and
using the micro-heating apparatus to control the temperature in an cooperation with an injection process.

6. The method of claim 5, wherein the cooperation comprises:
before filling the plastic material, measuring the temperature around the interface of the plastic material and the micro-heater where the plastic material easily solidifies;
using the programmable external power device to control the micro-heater to preheat the interface so as to raise the local temperature, so that the plastic material easily flows through the injection mold when the plastic material is filled and compressed;
using the micro-heater to locally anneal the plastic material at the microstructures with a high aspect ratio after filling the plastic material so as to prevent the plastic material from becoming deformed resulting from a residual stress; and
adjusting a power by the micro-heater module and controlling a feedback of the temperature detector to generate a specific temperature gradient so that the plastic material has a best temperature during a cooling process to prevent a product from becoming deformed.
